(19) United States
(12) Patent Application Publication
(10) Pub. No.: US 2022/0193582 A1
(43) Pub. Date: Jun. 23, 2022

(54) ALTERNATING TANGENTIAL FLOW PUMPING METHOD

(71) Applicant: REPLIGEN CORPORATION, Waltham, MA (US)

(72) Inventor: Rudolf Pavlik, Dover, MA (US)

(73) Assignee: REPLIGEN CORPORATION, Waltham, MA (US)

(21) Appl. No.: 17/601,653

(22) PCT Filed: May 21, 2020
(86) PCT No.: PCT/US2020/034033

§ 371 Date: Oct. 5, 2021

Related U.S. Application Data
(60) Provisional application No. 62/850,718, filed on May 21, 2019.

(51) Int. Cl. B01D 35/26; B01D 29/90; F04B 43/04; F04B 43/00; F04B 53/20

(52) U.S. Cl. CPC B01D 35/26; B01D 29/90; B01D 2313/243; F04B 43/0081; F04B 53/20; F04B 43/04

(57) ABSTRACT

The present disclosure relates generally to alternating tangential flow (ATF) perfusion pumping methods, including novel methods for generating positive and negative pressure at the point of use, and more particularly, to apparatuses, systems and methods for use of the same.

### PRIORITY

This application claims the benefit of priority under 35 U.S.C. § 119 to United States Provisional Patent Application Serial No. 62/850,718, filed May 21, 2019, which is incorporated by reference herein in its entirety and for all purposes.

### FIELD OF DISCLOSURE

The present application relates generally to alternating tangential flow (ATF) perfusion pumping methods, and more particularly, to apparatuses, systems and methods for use of the same.

### BACKGROUND

Filtration is typically performed to separate, clarify, modify and/or concentrate a fluid solution, mixture or suspension. In the biotechnology and pharmaceutical industries, filtration is vital for the successful production, processing, and testing of new drugs, diagnostics and other biological products. For example, in the process of manufacturing biologicals, using animal cell culture, filtration is done for clarification, selective removal, and concentration of certain constituents from the culture media or to modify the media prior to further processing. Filtration may also be used to enhance productivity by maintaining a culture in perfusion at high cell concentration.

Filter chemistries, configurations, and modalities of use have been developed to facilitate separation of materials according to their chemical and physical properties. In spite of the extensive developments in filter technology, filters are generally limited by their tendency to clog. For example, when used to filter a suspension of cultured mammalian cells, they tend to clog with dead cells, cell debris, aggregates, fibrous biomolecules, or other constituents found in the complex “soup” of a culture. In this regard, the method of filtration can have a profound effect on the filtration efficiency and the longevity of the membrane. In one kind of filtration process, commonly known as “dead end” filtration, the entire fluid is passed through the membrane perpendicular to the membrane surface. Debris rapidly accumulates at the surface resulting in rapid blockage of the membrane. Typically, applications using dead end filtration involves small samples. The process is simple and relatively inexpensive. Another filtration process, generally known as Tangential Flow Filtration (also known as TFF) offers an improvement over dead end filtration. In TFF, fluid to be filtered is recirculated with a pump, typically, from a reservoir through a filter and back to the reservoir. The flow through the filter is parallel to the surface of the filter. Any accumulation of debris is effectively removed by the “washout” effect of the circulating fluid; nevertheless, one of its limitations is the tendency to form a gelatinous deposit on the filter surface, which may limit the effectiveness of the filter and eventually clogging it. Another processes, known as alternating tangential flow filtration (ATF), offers yet another mode of filtration. ATF is similar to TFF in that it generates a flow pattern parallel to the filtration membrane surface; however, it differs from TFF in that the direction of flow is repeatedly alternating or reversing across the filter surface. The alternating tangential flow filtration system described in U.S. Pat. No. 6,544,424 to Shevitz, the entire contents of which are incorporated herein, consists of a filter element, commonly a hollow fiber cartridge, connected at one end to a reservoir containing the content to be filtered and at the other end connected to a diaphragm pump capable of receiving and reversibly expelling the unfiltered liquid flowing reversibly between reservoir and pump through the filter element. The system has shown the ability to sustain filtration of complex mixtures, including the medium of a cell culture, even when that medium is burdened with high cell concentration and other cellular products. That system, however, is limited in its range of applications.

A wide variety of filtration systems exist that are adapted to large-scale filtration of media across various applications. However, such systems require positive and negative pressure supplies. Positive and negative pressure may be supplied by a facility, where it is shared by other users and where variations in consistency result due to distance from the pressure source. Positive and negative pressure may also be supplied by a generator, which can be loud and obtrusive in a lab setting. Current systems do not precisely modulate the duration of the transition between the positive and negative air flows or the amount of air flow. Moreover, current systems typically involve many components in complicated assemblies, which are difficult to maintain. The embodiments of the present disclosure, on the other hand, allow for precise control over the duration of the transition and amount, as described in more detail below.

### SUMMARY

[symbol]

### BRIEF DESCRIPTION OF DRAWINGS

FIG. 1 is an image of a filter connected to a cylinder with piston.

FIGS. 2A-B are schematics showing both positions of the pressure and vacuum generating piston and the corresponding positions of the diaphragm.

FIG. 3 is a schematic showing dual filter activation coupled to the same air and vacuum generating cylinder, with the diaphragms working in out of face mode.

### DETAILED DESCRIPTION

Overview

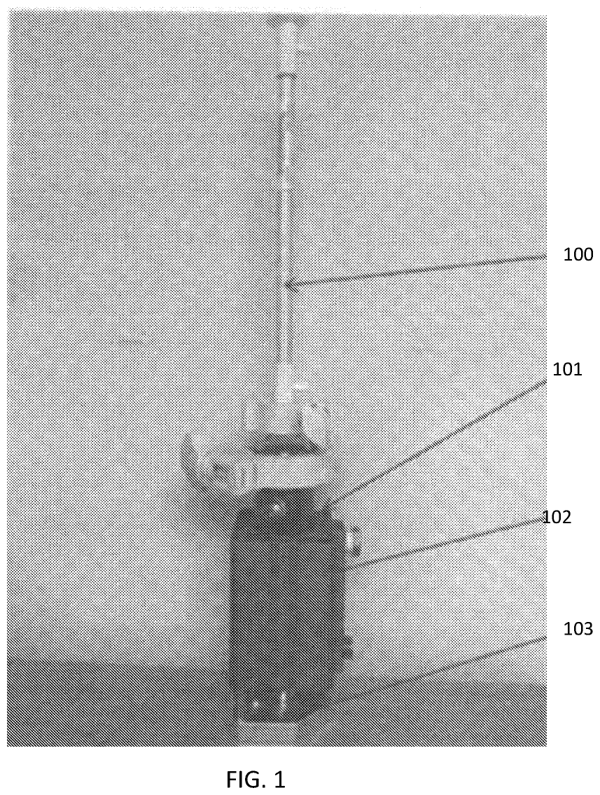

The present application discloses an alternating tangential flow (ATF) pumping method in which the positive and negative pressure is generated at the point of use. This method uses a pneumatic cylinder which is connected to the diaphragm pump of the ATF filter. This pneumatic cylinder contains a piston which allows for the controlled creation of positive and negative pressure on the diaphragm. Movement of the diaphragm allows for the intake and expulsion of fluid through the ATF filter. FIG. 1 shows an embodiment of the present disclosure. As shown in FIG. 1, the filter 100 is connected to a cylinder 102 by a base locking feature 101. The cylinder 102 further connects to a linear servo via a connection 103.

The end of the cylinder without the piston connecting linkage has an opening in the center which opens to the functional chamber of the cylinder. The bottom of a filter hemisphere base has an opening which matches that of the cylinder end. The cylinder face has a locking system which corresponds with receivers on the filter to allow a firm connection between the filters and the pressure and vacuum source. At the point of connection, the opening in the pressure and vacuum source is activated by a linear servo or electrical linear actuator.

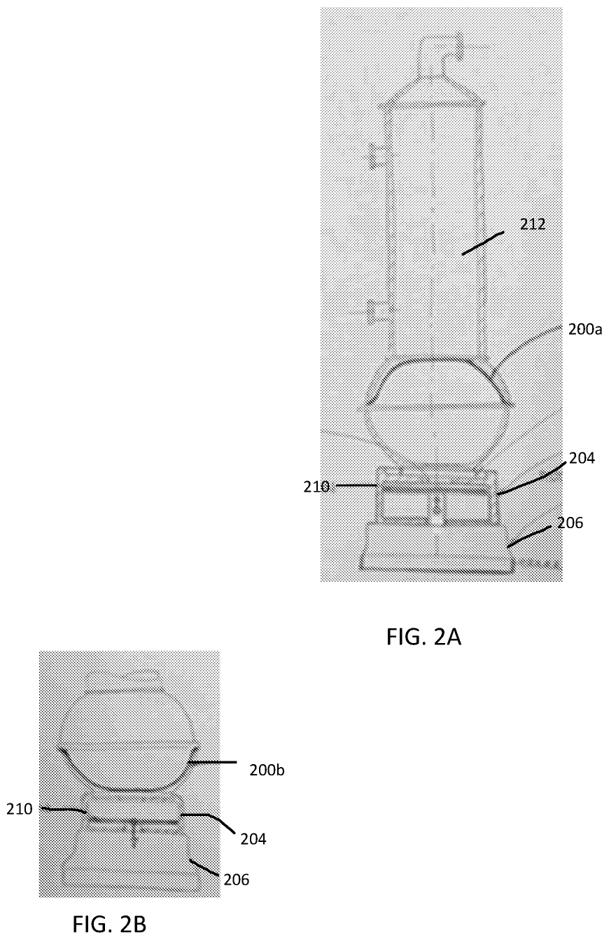

FIG. 2A shows an embodiment of the device wherein the diaphragm 200a is in the top position. Within the cylinder 204, the piston 210 generates positive pressure by moving towards the filter 212. FIG. 2B shows an embodiment of the device wherein the diaphragm 200b is in the bottom position, as the piston 210 generates negative pressure by moving down, towards the linear servo 206.

The linear servo or electrical linear actuator is connected to a piston which enters the cylinder through the end opposite that which connects to the filter. As the piston moves away from the filter base, vacuum is generated and cell culture is pulled in to the filter housing. When the piston moves towards the filter, pressure is generated and cell culture is pushed out of the filter housing.

The speed and control of piston movement can be controlled by a linear servo or electrical linear actuator, which is then controlled by a PLC or PC commanded algorithm. To overcome air compressibility, continuous, even pressure and vacuum is applied to the filter hemisphere base, which contains a diaphragm pump.

The linear servo or electrical linear actuator is equipped with an encoder which allows the exact position of the piston to be known at any time. This allows movement of the piston in full or partial strokes, depending on the needs of the system. Therefore, in a system where different size filters are used, the piston system may adjust to provide the appropriate level of pressure or vacuum necessary.

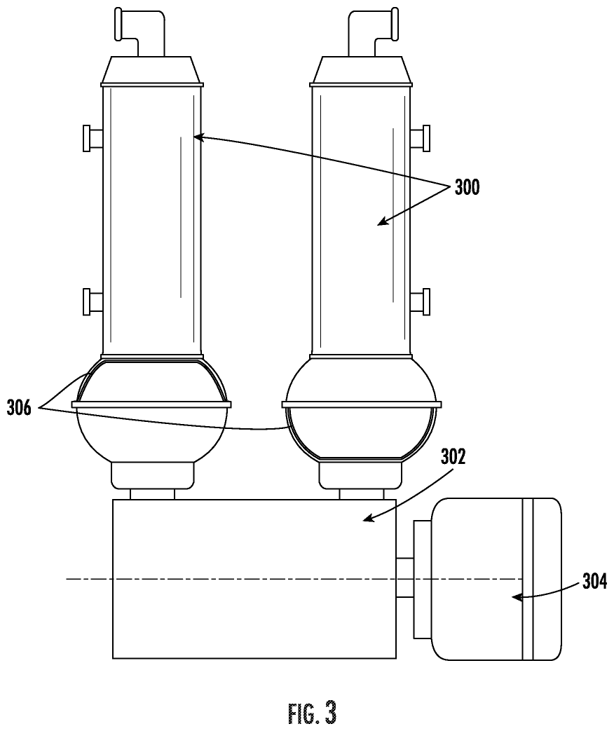

In embodiments of this disclosure, a single piston and cylinder may be connected to multiple ATF filter units to provide positive and negative pressure in parallel. For instance, when two filters are arranged in sequence, the cylinder may be attached to both such that when the piston moves to provide pressure to one filter, an equal vacuum is applied to the second filter, and vice versa. FIG. 3 shows an embodiment of the described system of multiple filters 300. Positive/negative pressure is generated in the cylinder 302, causing the diaphragms 306 to be out of phase. The linear servo 304 is attached to the cylinder 302.

The movement of the piston may be adjusted due to changed conditions within the system such as change of viscosity of the pumped liquid.

1. An alternating tangential flow pressure device comprising:
a pneumatic cylinder having a proximal end and a distal end, and defining a chamber therebetween, the proximal end being connected in series to a filter system, wherein the proximal end comprises an opening to the chamber; and
a piston connecting linkage entering the pneumatic cylinder through the distal end.

2. The device of claim 1, wherein the piston further comprises a linear servo.

3. The device of claim 2, wherein the linear servo further comprises an encoder.

4. The device of claim 3, wherein the position of the linear servo provides information as to actions occurring within the filter system.

5. An alternating tangential flow pumping method comprising:
connecting a pneumatic cylinder having a proximal end comprising a center opening, a distal end comprising a piston, and a chamber to a filter sphere base comprising a center opening, lining up the opening of the proximal end with the opening of the sphere base;
activating the piston with a linear servo; and
moving the piston in and out of the cylinder, creating positive and negative pressure.

6. The method of claim 5, further comprising tracking the movement of the piston by an encoder connected to the linear servo.

7. An alternating tangential flow pumping system comprising:
a pneumatic cylinder having a proximal end and a distal end, and defining a chamber therebetween, wherein the proximal end comprises an opening in the center of the proximal end which leads to the chamber;
a piston connecting linkage entering the pneumatic cylinder through the distal end;
a filter system, wherein the system comprises a sphere comprising a first and second hemisphere, wherein a diaphragm is between the first and second hemisphere, the first hemisphere connected to the distal end of a cylinder, wherein the proximal end of the cylinder connects to a source of liquid, wherein the cylinder contains a filter, and the proximal end of the pneumatic cylinder is connected in series to the filter system.

8. The system of claim 7, wherein the filter system comprises more than one sphere and cylinder.

9. The system of claim 8, wherein the filter system connects two filters and the piston moves such that the movement of one filter is out of phase with the other.

10. The system of claim 7, wherein the piston further comprises a linear servo.

11. The system of claim 10, wherein the linear servo further comprises an encoder.

12. The system of claim 11, wherein the encoder provides information regarding the state of the system.

13. An alternating tangential flow pumping system comprising:
a first pneumatic cylinder having a proximal end and a distal end, and defining a chamber therebetween, the proximal end being connected in series to a first filter system, wherein the proximal end comprises an opening in the center of the proximal end which leads to the chamber;
a second pneumatic cylinder having a proximal end, a distal end, and containing a chamber, the proximal end being connected in series to a second filter system, wherein the proximal end comprises an opening in the center of the proximal end which leads to the chamber;
a piston connecting linkage entering the pneumatic cylinder through the distal ends of each of the pneumatic cylinders;
the filter systems, wherein the systems comprise a hemisphere comprising a diaphragm, the hemisphere connected to the distal end of a cylinder, wherein the proximal end of the cylinder connects to a source of liquid, and wherein the cylinder contains a filter;
wherein the piston moves to provide pressure to the first filter, creating an equal vacuum on the second filter.

14. A method of controlling an alternating tangential flow filtration process, the method comprising:
selecting a volume or size of a diaphragm pump;
selecting a volume of a fluid to be displaced by the diaphragm pump over a given period of time;
selecting a duration of a pumping operation, which together with the desired volume of fluid to be displaced over the duration, generates a performance profile appropriate for a specific application;
actuating the pumping operation by alternating a supply of positive and negative air flow to the diaphragm pump using a linear servo.

15. (canceled)

16. The method of claim 14, further comprising receiving a position signal from the encoder of the linear servo during at least one cycle of alternating positive and negative airflow.

17. The method of claim 16, further comprising comparing the position signal to a measured process variable and modifying an amplitude, duration, or other characteristic of the cycle based upon the comparison.

18. A method of actuating a diaphragm pump comprising:
selecting a volume or size of a diaphragm pump;
selecting a volume of a fluid to be displaced by the diaphragm pump over a given period of time;
selecting a duration of a pumping operation, which together with the desired volume of fluid to be displaced over the duration, generates a performance profile appropriate for a specific application;
actuating the pumping operation by alternating a supply of positive and negative air flow using a piston attached to a linear servo within a chamber connected to the diaphragm pump;
monitoring the movement of the linear servo to maintain or alter the positive or negative air flow per unit of time chamber;
optionally, monitoring a position of a diaphragm of the diaphragm pump at one or both ends of its displacement; and
optionally, altering the positive or negative air flow within the chamber to influence either the position of the diaphragm at one or both ends of its displacement or a duration of a partial or full cycle of displacement or both.

19. The method of claim 18, further comprising simultaneously filtering the fluid suctioned from the bioreactor through two filters, wherein the diaphragm pump activates both in out of phase mode.

20. The method of claim 18, further comprising using the piston position to model the current state of the system.

21. The method of claim 20, further comprising using the piston position to calculate transmembrane pressure in the system.
